(19) United States
(12) Patent Application Publication
(10) Pub. No.: US 2009/0322003 A1
(43) Pub. Date: Dec. 31, 2009

(54) Magnetic construction tool for temporally holding piping on construction strut fastening systems

(76) Inventors: Gregory Olean, Columbia Heights, MN (US); Bryan Tollman, Toronto (CA)

Correspondence Address: Mark A. Litman & Associates, P.A.;York Business Center, Suite 205, 3209 West 76th St., Edina, MN, 55435, US

(21) Appl. No.: 12/456,292

(22) Filed: Jun. 15, 2009

Related U.S. Application Data
(60) Provisional application No. 61/061,645, filed on Jun. 15, 2008.

(51) Int. Cl. B25B 11/00

(52) U.S. Cl. 269/8

(57) ABSTRACT

A tool and method of using that tool in construction to assist in fixing pipes during construction. The method includes:
a) providing a magnetically susceptible strut having a channel with a frontal opening formed by three walls forming three sides of the channel;
b) inserting the first arm of the tool of claim one inside the channel, with the magnet attaching the first arm to a wall of the channel adjacent the frontal opening, so that the second arm forms an angle of 90° or less with an end designated as an upper end of the strut;
c) placing a pipe within the angle of 90° or less and supporting the pipe solely by temporary forces securing the tool within the channel;
d) securing the pipe to the strut; and
e) removing the tool from the channel.

### RELATED APPLICATION DATA

This Application claims priority from U.S. Provisional Patent Application No.: 61/061,645, filed Jun. 15, 2008

### BACKGROUND OF THE INVENTION

1. Field of the Invention

The construction industry forms a fundamental part of an economy and represents a substantial monetary part thereof; thus labor productivity and labor opportunity savings are important to reducing building costs, increasing profitability and managing economic inflationary pressures.

2. Background of the Invention

Fastening electrical and plumbing piping to a building is (generally) done by way of a Strut Fastener System. Struts are a common commodity item used widely globally to efficiently organize and install piping configurations in (generally) commercial buildings. This task is performed thousands of times a day all over the world and generally takes two people working together to stage, hold and then permanently fasten the pipe to the strut. The STRUTFORCE™ tool allows this same task to be performed by one person, increasing Productivity and facilitating Opportunity Cost Savings on the second person's time and utility. Further, the STRUTFORCE™ TOOL functions on both vertically and invertedly mounted Strut Fastener Systems.

### BRIEF DESCRIPTION OF THE FIGURES

Embodiments of the invention are illustrated by way of example, and not by way of limitation, in the figures of the accompanying images:

FIG. 1 STRUTFORCE™ tool Product—Vertical Mode—Shows the STRUTFORCE™ tool; in Vertical use mode (Primary Arm would support piping).

FIG. 2 STRUTFORCE™ tool Product—Inverted Mode—Shows the STRUTFORCE™ tool in Inverted use mode using both the Primary and Secondary Inverted Arm to support piping.

FIG. 3 Strut Fastener System Design—Shows the Strut Design including the inside Strut Lip shape to which the STRUTFORCE™ tool attaches.

### DETAILED DESCRIPTION OF THE INVENTION

The technology described herein may include generic descriptions as follows. A construction tool for the temporary support of piping on a strut has:

a first arm and a second arm;

the first arm forming an angle of at least 90° with the second arm;

the first arm having a magnet (at least one relatively strong magnet, preferably at least two magnets and even three or more magnets) on one face of the first arm. The total of the magnets is capable of supporting a weight of at least 0.5 kg of iron when the tool is rotated about 360° and the weight is held horizontally in a balanced position (with respect to torque applied by the weight against the magnet). The second arm is rigidly fixed (either a rigid connection or a locking connection that holds the arms in a rigid, non-rotating relation with each other) to the first arm at the angle of at least 90°. The at least 90° is used so that a pipe supported between the two arms does not slip away from the angle formed by the two arms. The second arm may be rigidly fixed to the first arm at an angle of at least 100°, but less than 160°. The magnet on the first arm preferably has at least two magnets fixed to the first arm to provide rotational stability. One elongated magnet can also do such stabilization. The two magnets are preferably aligned with each other equidistant from at least one edge of the first arm. The tool may also have on the second arm a third arm hinged thereto. The third arm would be, distal from a point where the first arm is joined to the second arm. This construction of the tool is particularly useful in situations where a strut is far from vertical when being worked on, and can be used when the strut is perfectly horizontal, as explained herein. The third arm should be limited in ability to rotate in a first direction with respect to the second arm such that when the limited ability is reached, the third arm is stable against any further rotation. By stable it is meant that the application of at least one kg of force against the outermost edge of the third arm will not cause the third arm to rotate further beyond the limited ability to rotate. A post or ledge, for example, extends from the second arm such that rotation of the third arm causes the third arm to be stopped by abutting the post or ledge. The third arm may be also limited in its ability to rotate counter to rotation in the first direction by a barrier on the first arm, such a barrier possibly being formed by a magnet or a cover on the magnet on the first arm. The third arm may rotate about a rivet that secures the third arm to the second arm.

A method of assisting in the attachment of a pipe to a strut using the above described tool would have at least some of the following steps:
a) providing a magnetically susceptible strut having a channel with a frontal opening formed by three walls forming three sides of the channel;
b) inserting the first arm of the tool of claim one inside the channel, with the magnet attaching the first arm to a wall of the channel adjacent the frontal opening, so that the second arm forms an angle of 90° or less with an end designated as an upper end of the strut;
c) placing a pipe within the angle of 90° or less and supporting the pipe solely by temporary forces securing the tool within the channel;
d) securing the pipe to the strut; and
e) removing the tool from the channel.
   The strut is may be first fixed within a construction so that one end of the strut is elevated above another end of the strut, and the elevated end is the upper end. The first arm, when inserted into the channel, is secured both by the at least one magnet against the wall and by an edge of the first arm engaging a ridge within the first channel. The at least two magnets are on the first arm and both magnets secure to the same wall of the channel adjacent the frontal opening. The strut may be fixed within a construction so that one end of the strut is at approximately a same elevation with respect to another end of the strut, and an end closest to a wall of the construction or furthest from a wall of the construction is the upper end. The second arm may have a third arm hinged thereto, distal from a point where the first arm is joined to the second arm, and the third arm is pivoted to form a pipe support with the second arm, the pipe support being able to support a pipe laying horizontally within the pipe support, and placing a pipe within the pipe support before step d). When the third arm is pivoted, it may engage a post or ledge on the second arm that limits rotation of the third arm at an angle of 90 degrees or less.

Reference to the Figures will assist in a further appreciation of the scope of the invention.

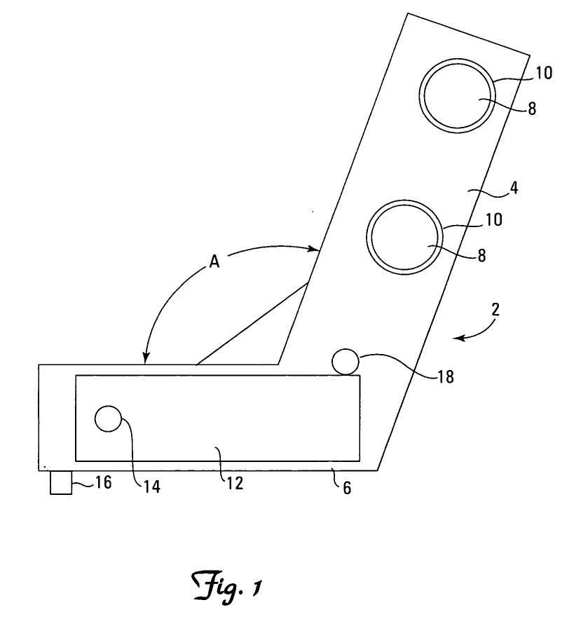

FIG. 1 shows a tool 2 according to the presently described technology. The tool 2 has a first arm 4 and a second arm 6. The first arm 4 has two magnets 8 (shown with protective covers 10) around each magnet 8. A third arm 12 is shown that pivots with respect to the second arm 6 around a rivet/bolt 14. A post 16 limits the rotation of the third arm in the clockwise rotation of the third arm 12. Another post 18 (or one of the magnets in a different location) prevents rotation of the third arm 12 in the counterclockwise rotation. The angle a is greater than 90° and preferably less than 160°. The angle may vary outside of that range, but at less than 90° pipes might tend to slip somewhat and at greater than 160°, the size of pipes would be more limited. Both electrical and water pipes and structural conduits or pipes are contemplated.

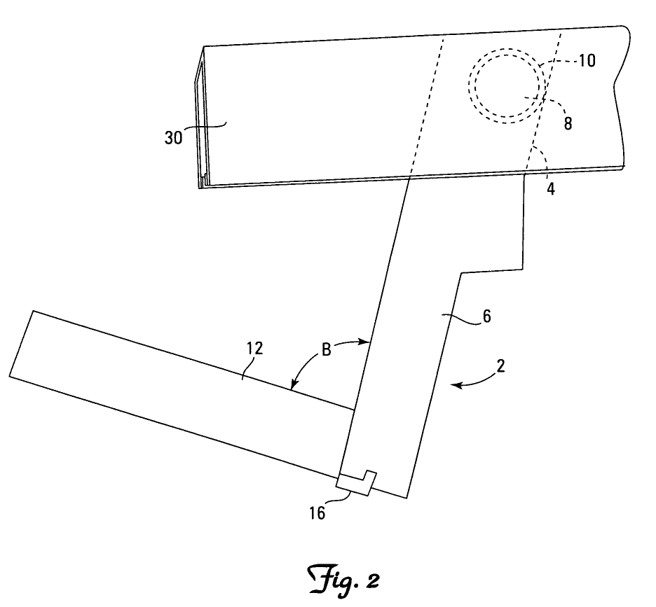

FIG. 2 shows a tool 2 according to the present technology with the first arm 4 within a strut 30, the second arm 6 extending at an angle from the strut 30, and the third arm 12 extended and rotated to its limit against pin 16. A pipe would be temporarily supported within angle B of the pipe support formed by extension/rotation of the third arm 12.

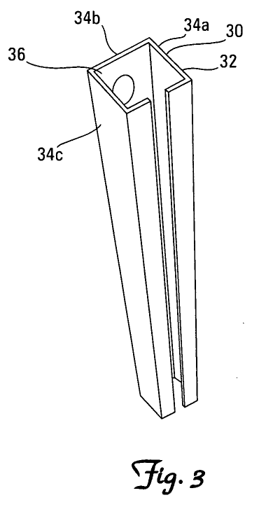

FIG. 3 shows a strut 30 having the three walls 34a, 34b and 34c forming the channel 36. A ledge 32 is shown, and this is the ledge along which an edge of the first arm (not shown) would be secured while magnets (not shown) on the first arm (not shown) secure the tool (not shown). That securing can be envisioned by reference back to FIG. 2.

In the following description, for the purposes of explanation, specific details are set forth in order to provide a thorough understanding of the invention. However, it will be apparent that the invention may be practiced without these specific details. STRUTFORCE™ tool

The STRUTFORCE™ tool can be made from a variety of materials, shapes, weights including but not limited to metals and rivets. The STRUTFORCE™ tool is a simple design made from two pieces of metal. The first, a single piece of metal, consisting of a Leg hosing two powerful Holding Magnets and the Primary Arm extending diagonally out from the top of the Leg section upon which the pipes rest. The diagonal Primary Arm design ensures that the pipe is held against the strut and stops the pipe from moving forward or falling. A second piece of metal consists of a secondary Inverted Arm attached to the Primary Arm by a Rivet Fastener. When in Vertical Mode the secondary Inverted Arm is folded behind the Primary Arm and performs no function. When used in Inverted Mode the Secondary Inverted Arm is drawn forward from behind the Primary Arm and held in place by a Metal Stopper formed from an extension of the Primary Arm's design.

The STRUTFORCE™ tool uses powerful Holding Magnets to fix itself laterally to the inside of the strut from. To further strengthen the STRUTFORCE™ tool attachment to the strut, the top, front end of the STRUTFORCE™ tool's Leg leans into the forward lip 3 of the strut stopping the STRUTFORCE™ tool from moving forward while the lower, rear end of the Leg pushes up against the inside, rear of the strut form. It is these three combined points of attachment which provide the STRUTFORCE™ tool with its holding strength.

In the foregoing specification, the invention has been described with reference to specific embodiments thereof. However, various modifications and changes may be made thereto without departing from the broader spirit and scope of the invention. The specification and drawings are, accordingly, to be regarded in an illustrative sense rather than a restrictive sense.

### Product Use and Process

### Assumptions

1. Strut Fastener System is attached to the wall as per OEM's install instructions, with the strut in place when the STRUFORCE™ tool is applied.
2. Place a STRUTFORCE™ tool at each end of the pipe's length (use additional STRUTFORCE™ tools as pipe weight requires) by inserting the STRUTFORCE™ tool into the inner form of the strut, attaching the two Holding Magnets to the inner form of the strut and ensuring the top, front of the STRUTFORCE™ tool Leg is firmly up against the inner side of the front Strut lip and the lower, rear of the STRUTFORCE™ tool Leg is firmly up against the inner side of the rear Strut form.
3. Place pipe on top of the Primary Arm.
4. Using the Strut Fastener System's accessories permanently fix the pipe to the strut.
5. Pushing the STRUTFORCE™ TOOL laterally to remove the magnets from the strut and out from the strut.

### 3 See FIG. 3 of the Strut Form Lip.

The STRUTFORCE™ tool is a construction tool which when mounted to a construction Strut Fastener System temporarily holds electrical piping in place, resting on the STRUTFORCE™ tool's Primary Arm, on the strut while the electrician permanently attaches the piping to the Strut Fastener System. The STRUTFORCE™ tool's utility is productivity as without a STRUTFORCE™ tool set, two or more people could be needed to do the same work. The STRUTFORCE™ tool allows the electrician to gently tap the STRUTFORCE™ tool upward to attain the desired precise pipe position on the strut. The STRUTFORCE™ tool works both on vertically and inverted mounted Strut Fasteners. Two STRUTFORCE™ tools are used to hold a pipe in place, one at each end of the pipe. Using the Inverted Arm, the STRUTFORCE™ tool is capable of holding electrical piping while mounted inverted on a strut attached to a ceiling.

When deployed the STRUTFORCE™ tool's second Inverted Arm, forms a holding “arm” for piping. The STRUTFORCE™ tool uses powerful Holding Magnets and lateral friction forces toward and against the inside shape of the Strut Fastener System to stay in place on the Strut Fastener System and hold the pipe while it is being permanently attached. After both sides of the pipe have been permanently attached to the Strut Fastener System, the STRUTFORCE™ tool is removed. The STRUTFORCE™ tool sets will function similarly with the smaller diameter, lighter of the plumbing pipes with additional STRUTFORCE™ tools being used (on the same pipe) to support heavier pipes

The primary focus of the STRUTFORCE™ tool is to improve the productivity of costly labor allowing one person to do the work which would have taken more than one people. Further, to provide this productivity to both vertical and inverted pipe attachment design situations. The STRUTFORCE™ tool can be made from a variety of materials, shapes, weights including but not limited to metals and rivets.

What is claimed:

1. A construction tool for the temporary support of piping on a strut, the tool comprising:
a first arm and a second arm;
the first arm forming an angle of at least 90° with the second arm;
the first arm having a magnet on one face of the first arm that is capable of supporting a weight of at least 0.5 kg of iron when the tool is rotated about 360°;
the second arm being rigidly fixed to the first arm at the angle of at least 90°.

2. The tool of claim 1 wherein the second arm is rigidly fixed to the first arm at an angle of at least 100°, but less than 160°.

3. The tool of claim 1 wherein the magnet on the first arm comprises at least two magnets fixed to the first arm.

4. The tool of claim 3 wherein the two magnets are aligned with each other equidistant from at least one edge of the first arm.

5. The tool of claim 1 wherein the second arm has a third arm hinged thereto, distal from a point where the first arm is joined to the second arm.

6. The tool of claim 5 wherein the third arm is limited in ability to rotate in a first direction with respect to the second arm such that when the limited ability is reached, the third arm is stable against any further rotation.

7. The tool of claim 6 wherein a post extends from the second arm such that rotation of the third arm causes the third arm to be stopped by abutting the post.

8. The tool of claim 6 wherein the third arm is also limited in its ability to rotate counter to rotation in the first direction by a barrier on the first arm.

9. The tool of claim 8 wherein the barrier on the first arm comprises a magnet or a cover on the magnet.

10. The tool of claim 5 wherein the third arm rotates about a rivet that secures the third arm to the second arm.

11. A method of assisting in the attachment of a pipe to a strut comprising:
f) providing a magnetically susceptible strut having a channel with a frontal opening formed by three walls forming three sides of the channel;
g) inserting the first arm of the tool of claim one inside the channel, with the magnet attaching the first arm to a wall of the channel adjacent the frontal opening, so that the second arm forms an angle of 90° or less with an end designated as an upper end of the strut;
h) placing a pipe within the angle of 90° or less and supporting the pipe solely by temporary forces securing the tool within the channel;
i) securing the pipe to the strut; and
j) removing the tool from the channel.

12. The method of claim 11 wherein the strut is fixed within a construction so that one end of the strut is elevated above another end of the strut, and the elevated end is the upper end.

13. The method of claim 12 wherein the first arm, when inserted into the channel, is secured both by the at least one magnet against the wall and by an edge of the first arm engaging a ridge within the first channel.

14. The method of claim 13 wherein at least two magnets are on the first arm and both magnets secure to the same wall of the channel adjacent the frontal opening.

15. The method of claim 11 wherein the strut is fixed within a construction so that one end of the strut is at approximately a same elevation with respect to another end of the strut, and an end closest to a wall of the construction or furthest from a wall of the construction is the upper end.

16. The method of claim 15 wherein the second arm has a third arm hinged thereto, distal from a point where the first arm is joined to the second arm, and the third arm is pivoted to form a pipe support with the second arm, the pipe support being able to support a pipe laying horizontally within the pipe support, and placing a pipe within the pipe support before step d).

17. The method of claim 16 wherein when the third arm is pivoted, it engages a post on the second arm that limits rotation of the third arm at an angle of 90 degrees or less.
